(19) United States
(12) Patent Application Publication
(10) Pub. No.: US 2006/0209951 A1
(43) Pub. Date: Sep. 21, 2006

(54) Method and system for quantization in a video encoder

(76) Inventor: Qin-Fan Zhu, Acton, MA (US)

Correspondence Address: MCANDREWS HELD & MALLOY, LTD, 500 WEST MADISON STREET, SUITE 3400, CHICAGO, IL, 60661, US

(21) Appl. No.: 11/084,511

(22) Filed: Mar. 18, 2005

(51) Int. Cl. H04N 11/04; H04N 7/12; H04B 1/66; H04N 11/02

(52) U.S. Cl. 375/240.03; 375/240.18; 375/240.12

(57) ABSTRACT

Described herein is a method and system for quantization in a video encoder. Human eyes have a different sensitivity to different frequency components of a picture. The eye may be less sensitive to variation of a higher spatial frequency and a corresponding portion of the picture would have a low perceptual value. The method and system for quantization can allocate bandwidth based on a model of perceptual value and a method of coding. A low perceptual value can be associated with a lower average bandwidth.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Video communications systems are continually being enhanced to meet requirements such as reduced cost, reduced size, improved quality of service, and increased data rate. In addition to quantitative measures, video can also be judged subjectively. Human response to visual stimulus is not uniform. The eye can perceive some aspects of a picture with more acuity than others.

Many advanced processing techniques can be specified in a video compression standard. Typically, the design of a compliant video encoder is not specified in the standard. Optimization of the communication system's requirements is dependent on the design of the video encoder.

Limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Described herein are system(s) and method(s) for encoding video data, substantially as shown in and/or described in connection with at least one of the figures, as set forth more completely in the claims.

These and other advantages and novel features of the present invention will be more fully understood from the following description.

### BRIEF DESCRIPTION OF THE DRAWINGS

FIG. 1 is a block diagram describing the transformation and quantization of a prediction in accordance with an embodiment of the present invention;

FIG. 2 is a block diagram of a quantizer in accordance with an embodiment of the present invention;

FIG. 3 is a flow diagram of an exemplary method for quantization in accordance with an embodiment of the present invention;

FIG. 4 is a block diagram of an exemplary picture in the H.264 coding standard in accordance with an embodiment of the present invention;

FIG. 5 is a block diagram describing temporally encoded macroblocks in accordance with an embodiment of the present invention;

FIG. 6 is a block diagram describing spatially encoded macroblocks in accordance with an embodiment of the present invention; and

FIG. 7 is a block diagram of an exemplary video encoding system in accordance with an embodiment of the present invention.

### DETAILED DESCRIPTION OF THE INVENTION

According to certain aspects of the present invention, a system and method for quantization in a video encoder are presented.

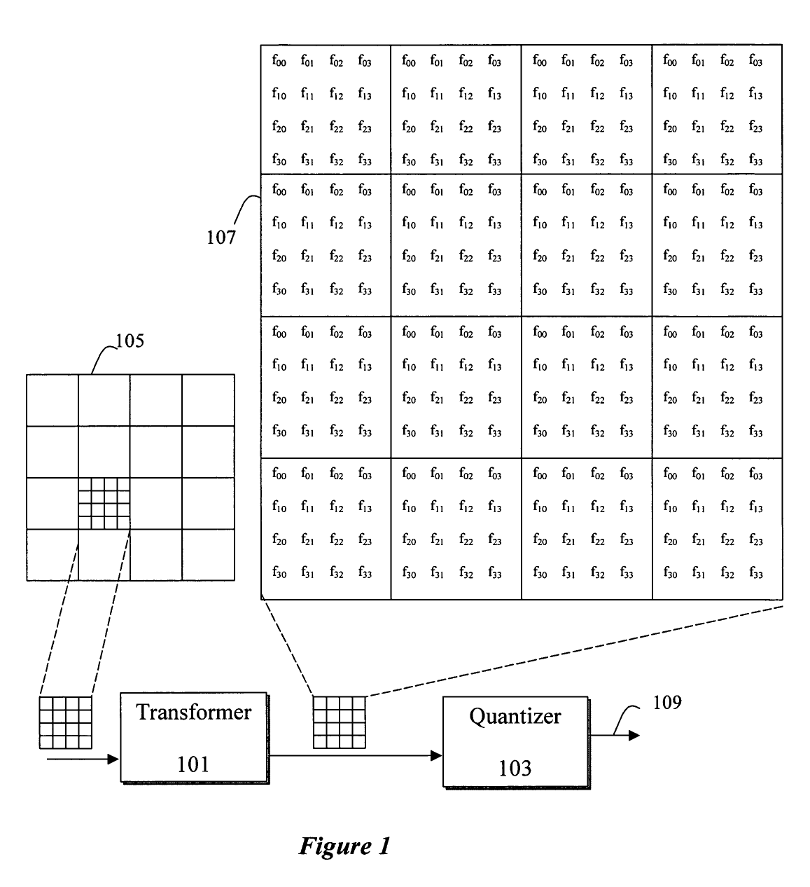

In FIG. 1, there is illustrated a block diagram describing a transformation and quantization of a set of video samples 105. The transformer 101 transforms partitions of the video samples 105 to the frequency domain, thereby resulting in a corresponding set of frequency coefficients 107. The frequency coefficients 107 are then passed to a quantizer 103, resulting in set of quantized frequency coefficients 109. The quantizer 103 can be programmed with a quantization level or step size.

Human eyes have a different sensitivity to different frequency components. The eye may be less sensitive to variation of a higher spatial frequency and the corresponding portion of video would have a low perceptual value. The perceptual value of a coded video section may also be dependent on the method of coding.

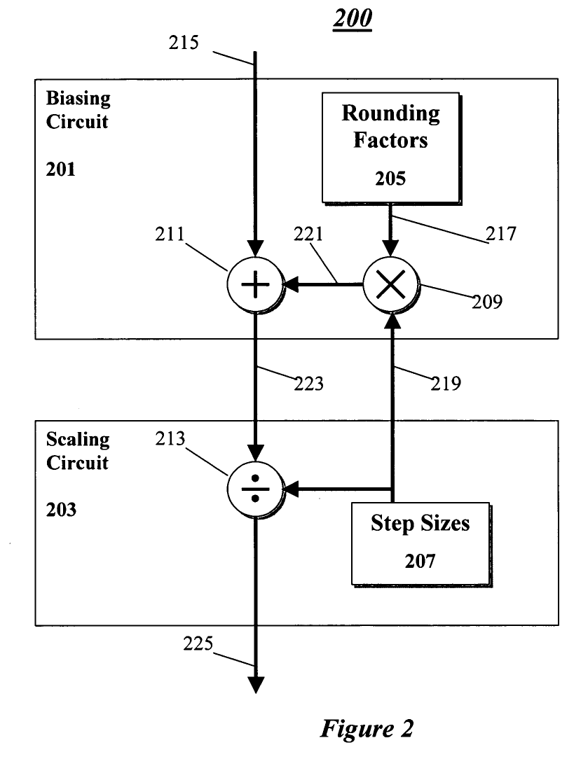

Referring now to FIG. 2, there is illustrated a block diagram of a quantizer 200 comprising a biasing circuit 201 and a scaling circuit 203. The biasing circuit 201 biases a frequency-based coefficient 215 to produce an adjusted frequency-based coefficient 223. The adjusted frequency-based coefficient 223 is scaled by a scaling circuit 203 to produce the quantizer output 225.

The quantizer 200 can be illustrated with an equation. The frequency-based coefficient X 215 is to be quantized by a step size Y 219 that is chosen from a set of step sizes 207. The quantizer output Z 225 is given by Z=(X+R)/Y. The summer 211 and the divider 213 can be defined according to fixed-point arithmetic. Specifically, the result 225 of the division may result in a loss of precision when the step size 219 is larger than the least significant bit of (X+R) 223. R 221 can be chosen as C 217 multiplied 209 by Y 219 where C 217 is one of a set of rounding factors 205. The rounding factor C 217 is typically between 0 and ½.

Some factors that are considered in video encoding include subjective quality, bandwidth, and peak signal-to-noise ratio. The subjective quality comprises a perceptual value of video. The bandwidth is a measure of the number of bits required to encode a picture.

In the frequency domain, many coefficients can approach a value of zero. If a coefficient is rounded to zero, the corresponding number of bits required for transmission is reduced. A smaller rounding factor can, on average, increase the number of coefficients that are rounded to zero. Therefore, if the perceptual value of a frequency coefficient is low the rounding factor can be lowered without a detrimental effect to the subjective quality, but setting the rounding factor lower for all frequency coefficients can reduce peak signal to noise ratio.

A different rounding factor 217 can be used for different coefficients 215. A set of rounding factors 205 can be used to emphasize spatial frequency components with higher perceptual value, and a spatial frequency with low perceptual value will be more likely to be rounded to zero.

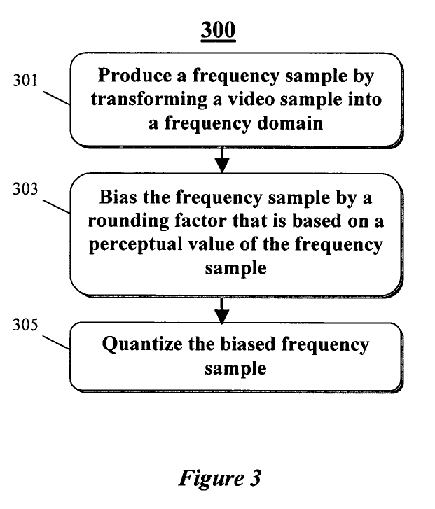

FIG. 3 is a flow diagram of an exemplary method for deciding the mode while video encoding in accordance with an embodiment of the present invention.

Produce a frequency sample by transforming a video sample into a frequency domain at 301. The video sample is a time domain representation that may comprise a set of prediction errors produced by a motion estimator or spatial predictor.

Bias the frequency sample by a rounding factor that is based on a perceptual value of the frequency sample at 303. If the perceptual value is low, the rounding factor can be low. Human eyesight will generally have a low perceptual value for high spatial frequencies. Quantize the biased frequency sample at 305. Dividing a fixed-point biased frequency sample by a fixed-point step size and saving only the integer result can accomplish quantizing and rounding.

The invention can be applied to video data encoded with a wide variety of standards, one of which is H.264. An overview of H.264 will now be given. A description of an exemplary quantizer for H.264 will also be given.

H.264 Video Coding Standard

The ITU-T Video Coding Experts Group (VCEG) and the ISO/IEC Moving Picture Experts Group (MPEG) drafted a video coding standard titled ITU-T Recommendation H.264 and ISO/IEC MPEG-4 Advanced Video Coding, which is incorporated herein by reference for all purposes. In the H.264 standard, video is encoded on a macroblock-by-macroblock basis. The generic term “picture” is used throughout this specification to refer to frames, fields, slices, blocks, macroblocks, or portions thereof.

The specific algorithms used for video encoding and compression form a video-coding layer VCL, and the protocol for transmitting the VCL is called the Network Access Layer (NAL). The H.264 standard allows a clean interface between the signal processing technology of the VCL and the transport-oriented mechanisms of the NAL, so no source-based encoding is necessary in networks that may employ multiple standards.

By using the H.264 compression standard, video can be compressed while preserving image quality through a combination of spatial, temporal, and spectral compression techniques. To achieve a given Quality of Service (QoS) within a small data bandwidth, video compression systems exploit the redundancies in video sources to de-correlate spatial, temporal, and spectral sample dependencies. Statistical redundancies that remain embedded in the video stream are distinguished through higher order correlations via entropy coders. Advanced entropy coders can take advantage of context modeling to adapt to changes in the source and achieve better compaction.

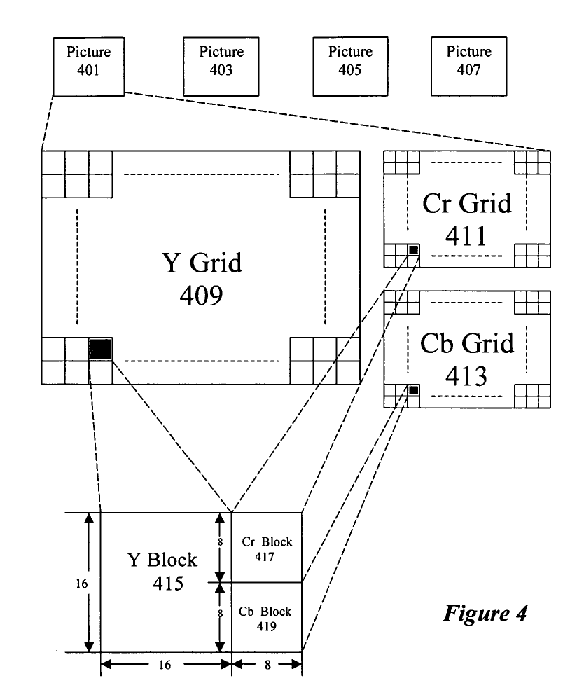

Referring now to FIG. 4, there is illustrated a block diagram of an exemplary picture 401. The picture 401 along with successive pictures 403, 405, and 407 form a video sequence. The picture 401 comprises two-dimensional grid(s) of pixels. For color video, each color component is associated with a unique two-dimensional grid of pixels. For example, a picture can include luma, chroma red, and chroma blue components. Accordingly, these components are associated with a luma grid 409, a chroma red grid 411, and a chroma blue grid 413. When the grids 409, 411, 413 are overlayed on a display device, the result is a picture of the field of view at the duration that the picture was captured.

Generally, the human eye is more perceptive to the luma characteristics of video, compared to the chroma red and chroma blue characteristics. Accordingly, there are more pixels in the luma grid 409 compared to the chroma red grid 411 and the chroma blue grid 413. The set of rounding factors 205 in FIG. 2 can be different for each grid type. In the H.264 standard, the chroma red grid 411 and the chroma blue grid 413 have half as many pixels as the luma grid 409 in each direction. Therefore, the chroma red grid 411 and the chroma blue grid 413 each have one quarter as many total pixels as the luma grid 409.

The luma grid 409 can be divided into 16×16 pixel blocks. For a luma block 415, there is a corresponding 8×8 chroma red block 417 in the chroma red grid 411 and a corresponding 8×8 chroma blue block 419 in the chroma blue grid 413. Blocks 415, 417, and 419 are collectively known as a macroblock that can be part of a slice group. Currently, subsampling is the only color space used in the H.264 specification. This means, a macroblock consist of a 16×16 luminance block 415 and two (subsampled) 8×8 chrominance blocks 417 and 418.

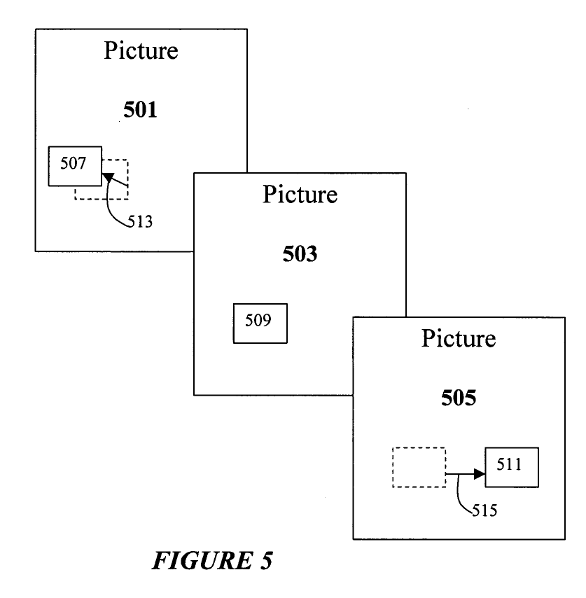

Referring now to FIG. 5, there is illustrated a block diagram describing temporally encoded macroblocks. In bi-directional coding, a current partition 509 in the current picture 503 is predicted from a reference partition 507 in a previous picture 501 and a reference partition 511 in a latter arriving picture 505. Accordingly, a prediction error is calculated as the difference between the weighted average of the reference partitions 507 and 511 and the current partition 509. The prediction error and an identification of the prediction partitions are encoded. Motion vectors 513 and 515 identify the prediction partitions.

The weights can also be encoded explicitly, or implied from an identification of the picture containing the prediction partitions. The weights can be implied from the distance between the pictures containing the prediction partitions and the picture containing the partition.

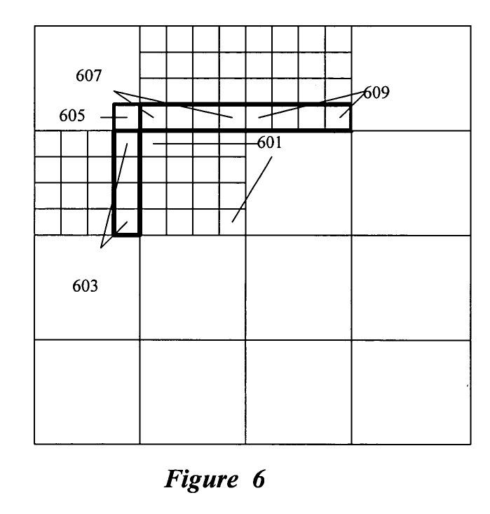

Referring now to FIG. 6, there is illustrated a block diagram describing spatially encoded macroblocks. Spatial prediction, also referred to as intraprediction, involves prediction of picture pixels from neighboring pixels. The pixels of a macroblock can be predicted, in a 16×16 mode, an 8×8 mode, or a 4×4 mode. A macroblock is encoded as the combination of the prediction errors representing its partitions.

In the 4×4 mode, a macroblock 601 is divided into 4×4 partitions. The 4×4 partitions of the macroblock 601 are predicted from a combination of left edge partitions 603, a corner partition 605, top edge partitions 607, and top right partitions 609. The difference between the macroblock 601 and prediction pixels in the partitions 603, 605, 607, and 609 is known as the prediction error. The prediction error is encoded along with an identification of the prediction pixels and prediction mode.

The prediction error is transformed to the frequency domain, thereby resulting in a corresponding set of frequency coefficients, which are quantized resulting in a set of quantized frequency coefficients, as shown in FIG. 1.

An H.264 encoder can generate three types of coded pictures: Intra-coded (I), Predictive (P), and Bi-directional (B) pictures. An I picture is encoded independently of other pictures based on a transformation, quantization, and entropy coding. I pictures are referenced during the encoding of other picture types and are coded with the least amount of compression. P picture coding includes motion compensation with respect to the previous I or P picture. A B picture is an interpolated picture that requires both a past and a future reference picture (I or P). The picture type I uses the exploitation of spatial redundancies while types P and B use exploitations of both spatial and temporal redundancies. Typically, I pictures require more bits than P pictures, and P pictures require more bits than B pictures.

Macroblocks in an I picture are all Intra-coded. Macroblocks in P and B pictures can be either Intra-coded or Inter-coded. For Intra-coded macroblocks, the rounding factor 217 of FIG. 2 can be around ⅓ to result in a favorable peak signal-to-noise ratio. For Inter-coded macroblocks, the rounding factor can be around ⅕ or ⅙ to result in a favorable peak signal-to-noise ratio.

Using the following rounding factors, for each 4×4 frequency coefficient matrix, can result in bit savings without loss to peak signal-to-noise ratio or subjective quality.

For Intra-Coded Macroblocks Add:

TABLE 1

| | | | |
|---|---|---|---|
| 0.41 | 0.39 | 0.35 | 0.32 |
| 0.39 | 0.35 | 0.32 | 0.27 |
| 0.35 | 0.32 | 0.27 | 0.23 |
| 0.32 | 0.27 | 0.23 | 0.20 |

For Inter-Coded Macroblocks Add:

TABLE 2

| | | | |
|---|---|---|---|
| 0.25 | 0.22 | 0.20 | 0.17 |
| 0.22 | 0.20 | 0.17 | 0.16 |
| 0.20 | 0.17 | 0.16 | 0.14 |
| 0.17 | 0.16 | 0.14 | 0.14 |

Specific rounding factors are given in TABLE 1 and TABLE 2 as an example. Rounding factors may be applied as a matrix larger or smaller than 4×4. Rounding factors may be adapted based on the perceptual results. High definition pictures and standard definition pictures may require different rounding factors. Adaptation of rounding factors based on content may be open loop or closed loop.

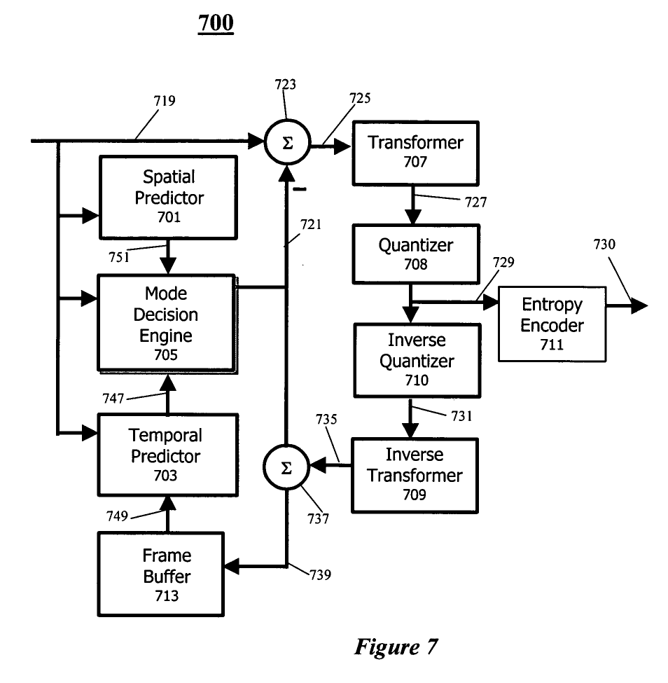

Referring now to FIG. 7, there is illustrated a block diagram of an exemplary video encoder 700. The video encoder 700 comprises a spatial predictor 701, a temporal predictor 703, a mode decision engine 705, a transformer 707, a quantizer 708, an inverse transformer 709, an inverse quantizer 710, a frame buffer 713, and an entropy encoder 711.

The spatial predictor 701 requires only the content of a current picture 719. The spatial predictor 701 receives the current picture 719 and produces spatial-predictors 751 corresponding to reference blocks as described in reference to FIG. 6.

Spatially predicted pictures are intra-coded. Luma macroblocks can be divided into 4×4 blocks or 16×16 blocks. There are 7 prediction modes available for 4×4 macroblocks and 4 prediction modes available for 16×16 macroblocks. Chroma macroblocks are 8×8 blocks and have 4 possible prediction modes.

In the temporal predictor 703 (i.e. motion estimator), the current picture 719 is estimated from reference blocks 749 using a set of motion vectors 747. The temporal predictor 703 receives the current picture 719 and a set of reference blocks 749 that are stored in the frame buffer 713. A temporally encoded macroblock can be divided into 16×8, 8×16, 8×8, 4×8, 8×4, or 4×4 blocks. Each block of a macroblock is compared to one or more prediction blocks in another picture(s) that may be temporally located before or after the current picture. Motion vectors describe the spatial displacement between blocks and identify the prediction block(s).

The Mode Decision Engine 705 will receive the spatial predictions 751 and temporal predictions 747 and select the prediction mode according to a rate-distortion optimization. A selected prediction 721 is output.

Once the mode is selected, a corresponding prediction error 725 is the difference 723 between the current picture 719 and the selected prediction 721. The transformer 707 transforms the prediction errors 725 representing blocks into transform values 727. In the case of temporal prediction, the prediction error 725 is transformed along with the motion vectors.

Transformation in H.264 utilizes Adaptive Block-size Transforms (ABT). The block size used for transform coding of the prediction error 725 corresponds to the block size used for prediction. The prediction error is transformed independently of the block mode by means of a low-complexity 4×4 matrix that together with an appropriate scaling in the quantization stage approximates the 4×4 Discrete Cosine Transform (DCT). The Transform is applied in both horizontal and vertical directions. When a macroblock is encoded as intra 16×16, the DC coefficients of all 16 4×4 blocks are further transformed with a 4×4 Hardamard Transform.

The quantizer 708 quantizes the transformed values 727. In H.264, there are 52 quantization levels. In certain embodiments of the present invention, the quantizer 708 can comprise the quantizer described in FIG. 2. For Intra-coded macroblocks, the quantizer 708 can use a rounding factor around ⅓ to result in a favorable peak signal-to-noise ratio. For Inter-coded macroblocks, the rounding factor can be around ⅕ or ⅙ to result in a favorable peak signal-to-noise ratio.

The quantizer 708 can use the rounding factors in TABLE 1 to achieve bit savings without loss to peak to peak signal-to-noise ratio or subjective quality, for each 4×4 frequency coefficient matrix in an intra-coded macroblock. The quantizer 708 can use the rounding factors in TABLE 2 to achieve bit savings without loss to peak to peak signal-to-noise ratio or subjective quality, for each 4×4 frequency coefficient matrix in an inter-coded macroblock.

H.264 specifies two types of entropy coding: Context-based Adaptive Binary Arithmetic Coding (CABAC) and Context-based Adaptive Variable-Length Coding (CAVLC). The entropy encoder 711 receives the quantized transform coefficients 729 and produces a video output 730. The quantized transform coefficients 729 are also fed into an inverse quantizer 710 to produce an output 731. The output 731 is sent to the inverse transformer 709 to produce a regenerated error 735. The original prediction 721 and the regenerated error 735 are summed 737 to regenerate reference pictures 739 that are stored in the frame buffer 713.

The embodiments described herein may be implemented as a board level product, as a single chip, application specific integrated circuit (ASIC), or with varying levels of a video classification circuit integrated with other portions of the system as separate components. An integrated circuit may store a supplemental unit in memory and use an arithmetic logic to encode, detect, and format the video output.

The degree of integration of the video classification circuit will primarily be determined by the speed and cost considerations. Because of the sophisticated nature of modern processors, it is possible to utilize a commercially available processor, which may be implemented external to an ASIC implementation.

If the processor is available as an ASIC core or logic block, then the commercially available processor can be implemented as part of an ASIC device wherein certain functions can be implemented in firmware as instructions stored in a memory. Alternatively, the functions can be implemented as hardware accelerator units controlled by the processor.

While the present invention has been described with reference to certain embodiments, it will be understood by those skilled in the art that various changes may be made and equivalents may be substituted without departing from the scope of the present invention.

Additionally, many modifications may be made to adapt a particular situation or material to the teachings of the present invention without departing from its scope. For example, although the invention has been described with a particular emphasis on MPEG-1 encoded video data, the invention can be applied to a video data encoded with a wide variety of standards.

Therefore, it is intended that the present invention not be limited to the particular embodiment disclosed, but that the present invention will include all embodiments falling within the scope of the appended claims.

1. A method for quantization in a video encoder, said method comprising:
adding a rounding factor to a frequency-based coefficient associated with a perceptual value, wherein said rounding factor is based on the perceptual value, thereby producing an adjusted frequency-based coefficient; and
quantizing the adjusted frequency-based coefficient.

2. The method of claim 1, wherein the rounding factor is low if the perceptual value is low.

3. The method of claim 1, wherein the perceptual value is determined by a visual frequency.

4. The method of claim 3, wherein the perceptual value is also determined by a coding type.

5. The method of claim 4, wherein the coding type is one of intra-coding and inter-coding.

6. The method of claim 4, wherein the coding type is one of chroma red, chroma blue, and luma.

7. The method of claim 1, further comprising:
transforming at least one time-base sample into the frequency based coefficient associated with the perceptual value.

8. A system for quantization in a video encoder, said system comprising:
a biasing circuit for adding a rounding factor to a frequency-based coefficient associated with a perceptual value, wherein said rounding factor is based on the perceptual value, thereby producing an adjusted frequency-based coefficient; and
a scaling circuit for quantizing the adjusted frequency-based coefficient.

9. The system of claim 8, wherein the rounding factor is low if the perceptual value is low.

10. The system of claim 8, wherein the perceptual value is determined by a visual frequency.

11. The system of claim 10, wherein the perceptual value is also determined by a coding type.

12. The system of claim 11, wherein the coding type is one of intra-coding and inter-coding.

13. The system of claim 11, wherein the coding type is one of chroma red, chroma blue, and luma.

14. The system of claim 8, further comprising:
a transformer for transforming a time-based sample into the frequency-based coefficient, wherein the frequency-based coefficient is associated with the perceptual value.

15. An integrated circuit for video encoding, said integrated circuit comprising:
a memory for storing a table of rounding factors for biasing, wherein the table is indexed by at least one perceptual value; and
a circuit for biasing a frequency coefficient with a rounding factor from the table of rounding factors.

16. The integrated circuit of claim 15, wherein a rounding factor in the table of rounding factors is low if the perceptual value is low.

17. The integrated circuit of claim 15, wherein the perceptual value is determined by a visual frequency.

18. The integrated circuit of claim 17, wherein the perceptual value is also determined by a coding type.

19. The integrated circuit of claim 18, wherein the coding type is one of intra-coding and inter-coding.

20. The method of claim 18, wherein the coding type is one of chroma red, chroma blue, and luma.
